(19) United States
(12) Patent Application Publication
(10) Pub. No.: US 2025/0196482 A1
(43) Pub. Date: Jun. 19, 2025

(54) SELF-ADHESIVE MULTILAYER DEVICE IMPREGNATED WITH A SEMIOCHEMICAL SUBSTANCE

(71) Applicant: CEVA SANTE ANIMALE, Libourne (FR)

(72) Inventors: Yannick ESCUDIE, NOUSTY (FR); Sylvain BOURRIGAUD, MORLANNE (FR)

(21) Appl. No.: 18/847,127

(22) PCT Filed: Mar. 17, 2023
(86) PCT No.: PCT/FR2023/050381

§ 371 Date: Sep. 13, 2024

(30) Foreign Application Priority Data
Mar. 17, 2022 (FR) FR2202365

(51) Int. Cl. B32B 27/30; B32B 7/12; B32B 23/04; B32B 38/08

(52) U.S. Cl. CPC B32B 27/308; B32B 7/12; B32B 23/04; B32B 38/08; B32B 2250/04; B32B 2307/7376

(57) ABSTRACT

The present invention relates to a self-adhesive multilayer device, successively comprising: (1) a first adhesive layer; (2) a support layer; (3) a second adhesive layer; (4) an active layer having a thickness of 5 μm to 500 μm and comprising a block copolymer and optionally a semiochemical substance, said block copolymer being an acrylic block copolymer comprising at least one alkyl polymethacrylate block and at least one alkyl polyacrylate block. The present invention also relates to a kit comprising one or more self-adhesive multilayer devices and a composition comprising a semiochemical substance; as well as to the use of this device or kit in a method for diffusing a semiochemical substance and for modifying a behavior in an animal.

### TECHNICAL SCOPE OF THE INVENTION

The present invention relates to a self-adhesive multilayer device that can be impregnated and recharged with a semiochemical substance and allows the diffusion of this semiochemical substance over time. The present invention also relates to a kit comprising one or more self-adhesive multilayer devices and a composition comprising a semiochemical substance. The present invention also relates to the use of this device or kit in a method for diffusing a semiochemical substance to modifying a behavior in an animal.

### PRIOR ART

Semiochemical substances (pheromones, kairomones, allomones and synomones) are volatile substances increasingly used in many fields, for example, for controlling animal behavior or for regulating insect pest populations.

These semiochemical substances are molecules that are chemically sensitive and more particularly sensitive to oxidation (especially in the presence of UV or free radicals) or to temperatures since they have unsaturated chemical bonds (double or triple bonds), alcohol groups or stretched ether rings. However, the formation of impurities by oxidation processes may have catastrophic effects on the effectiveness of the semiochemicals (an attractant may for example become a repellent, or the pheromone of one insect in particular can transform into the pheromone of another insect).

Semiochemical substances are generally composed of a mixture of organic molecules. Each molecule has its own volatility, so volatilities can vary greatly depending on the nature of the molecule. For optimum effect, each molecule in the mixture must be released in a controlled, balanced manner. One of the major problems that arises in order to be able to use these semiochemical substances optimally is the possibility of storing them and releasing them using materials that not only allow the preservation of the purity of the semiochemical substances during the manufacture of the device and during the time of use, but also allow a controlled release at sufficient levels over long periods of time. Another problem is to be able to load the materials several times in order to avoid having to manufacture and use a new item each time a usage is desired again.

Wicks dipped in a reservoir bottle can also be used for diffusion, but this system has the disadvantage of being cumbersome and costly in terms of materials (plastic bottle, non-recyclable solid wick).

Another method is to simply spray the semiochemicals onto a support surface. In this case, the user is faced with several distinct technical problems. The first problem is to slow down and control the diffusion of semiochemical substances over time. A second problem is the formation of an unsightly greasy stain in the spray application area. A third problem is protecting the deposit from unintentional wiping when it comes into contact with an object or fabric.

To solve this set of technical problems, there is a need to develop a compact diffuser for semiochemical substances, for example in the form of a thin film that can be applied to any type of surface, curved or flat. The latter must be able to form a compact reservoir of semiochemical substances with minimal volume and a large diffusion surface. It must be able to control the diffusion of semiochemicals over time, to prolong their effectiveness over 6 to 10 days, and to absorb semiochemicals quickly enough (in the order of a few minutes) to protect them from accidental wiping by contact with another surface, and to be able to be recharged with semiochemicals. This compact diffuser will advantageously have an aesthetic surface unaltered by the deposition of semiochemicals.

The use of polymeric matrices for the release of active substances, especially semiochemical substances, has been known for a long time since it was already mentioned, for example, in the review of Campion (D. G. Campion, Pestic. Sci. 1978, 9, 434-440). Reference is made especially in this publication to the use of rubber (or elastomeric) matrices. However, it is also emphasized that such matrices do not allow for continuous release over time and have a high sensitivity to atmospheric conditions.

Later, other elastomeric matrices were proposed: for example, in 1987, in U.S. Pat. No. 4,703,070. However, these elastomeric matrices require incorporating the active substance before the elastomeric matrix is completely crosslinked. However, because of their specific chemical structures (unsaturated bond, the presence of alcohol functions, etc.) few semiochemical substances can durably withstand either the high temperatures necessary at the end of crosslinking, or the reactive components of the prepolymer. Still, the activity of the semiochemical substances is greatly influenced by a very slight deterioration of the molecule (such as a change of isomerism, for example).

Another thermoplastic matrix for releasing semiochemicals was described in 1996 in U.S. Pat. No. 5,504,142. In this case, the matrix is a copolymer of the Pebax® type. Pebax® is a thermoplastic elastomer or a plasticizer-free flexible polyamide composed of a regular linear chain of rigid polyamide segments and flexible polyether segments. However, this type of matrix requires the use of a solvent acting, of the undecylenic acid type, as a vector to the active substance in order to penetrate the copolymer matrix. This solvent (derived from undecylenic acid with biocidal properties well known to a person skilled in the art) necessary for the implementation of the method described in this invention is potentially harmful to the environment or may have a negative interaction with animals. The presence of such solvents is therefore prohibitive for the use of such a matrix to store and release semiochemical substances.

Another family of copolymer matrices was then proposed based on polyethylene glycol (PEG). In 2005, for example, Brown et al. (J. Am. Chem. Soc. 2005, 127, 11238-11239), proposed using a copolymer based on polyethylene glycol (PEG) and a hyperbranched hydrophobic fluoropolymer to store and release an unsaturated terpene alcohol (geraniol). Although it shows large capacities to store this molecule, such a copolymer would lead to greatly reduced release times of the active substance, which is incompatible with the long-lasting release necessary in the use of semiochemicals in agriculture. In 2010, Shakil et al. (p. 228 of the review by M. Kah and Hofmann in Environment International 2014 (63) 224-235) proposed aqueous formulations based on amphiphilic copolymers containing PEG blocks to release insecticides. However, these aqueous formulations have the drawback of not being solid, and the presence of water may induce chemical modifications in the semiochemical substances.

The copolymer-based matrices of ethylene and vinyl acetate have also been tested for delivering bioactive compounds such as food attractants, pesticides, as described in U.S. Pat. No. 5,135,744. However, the mixture of the copolymer and of the bioactive compound and the final shaping (extrusion) must be carried out at high temperatures (between 80° C. and 110° C.), which cannot be carried out with most of semiochemical substances, which either cannot withstand these transformation conditions or rapidly evaporate at the outlet of the extruder, making the loading of semiochemical substance in the plastic difficult to control.

Other copolymers have also been proposed, for example in WO2012/095444, which describes the formation of microcapsules composed of several polymers including C1-C24-alkyl esters of acrylic acid. This type of matrix can be used only for semiochemical substances that do not have sensitivity to peroxides that are necessary for the polymerization of the matrix, that is, for a limited number of semiochemical substances. Similarly, international application WO2013/156249 describes a composition comprising a pesticide and a random copolymer which results from the copolymerization of acrylic and/or methacrylic acid (monomer A), poly(C₂-C₆ alkylene glycol) (mono-C₁₂-C₂₂-alkyl terminated) (monomer B) (meth)acrylate and C₁-C₈-alkyl (meth)acrylate (monomer C). However, this type of random copolymer is obtained once again by polymerization with a radical generator (in the examples of this patent, tert.-butylperpivalate) that, as previously highlighted, represents a danger of causing semiochemical substances to degrade. For example, it is well known that (E,Z)-7,9 dodecadienylacetate (sexual pheromone of the European grapevine moth) under such conditions transforms into (E,E)-7,9 dodecadienylacetate, which has no effect on the insect.

Likewise, EP0338732 describes a matrix for the release and diffusion of active substances such as fragrances and pheromones in the atmosphere. The matrix is permeable to active substances and is formed of a copolymer that may be softened sufficiently at a temperature of between 45° C. and 160° C. to incorporate the substances therein. The matrix is formed of a substantially linear block copolymer that is a reaction product of a polydiorganosiloxane that forms soft segments in said reaction product and a diisocyanate that forms hard segments, said soft segments comprising from 70 to 99% by weight, based on the weight of said copolymer. The problem with such a matrix is that its manufacture involves high temperatures not compatible with pheromones. Furthermore, once the pheromone has been diffused, it is not possible to reload the matrix.

The international application WO01/50859 also describes a slow-release insect repellent composition comprising an insect repellent, an oleophilic chemical soluble in insect repellent, and a carbohydrate matrix wherein the combination of the insect repellent and oleophilic chemical is entrapped in the matrix such that the repellent is slowly released from the matrix. The problem with this type of composition is that the solidification entails a drying step at temperatures incompatible with semiochemical substances that are very sensitive to heat and that will evaporate during this step. In addition, once the insect repellent compound has been fully diffused, the composition cannot be reloaded.

EP3187046 describes the use of block copolymers as a support material for releasing pheromones, the block copolymers being used in the form of millimeter-sized solid particles or granules. As diffusion distance plays a key role in diffusion kinetics, a person skilled in the art would not have used such a material in the form of a thin film, as he would have expected that a drastic reduction in material thickness would induce a drastic acceleration in pheromone diffusion, so that control of this diffusion would no longer be possible.

FR3032972 further describes a composition comprising a polymer elastomer phase in the form of an acrylic block copolymer and an odorous active compound enabling release of said odorous active compound for a given period of time. For instance, this document describes articles obtained by injection molding, extrusion, co-extrusion or extrusion/blow-molding leading to the preparation of profiled parts or elements, blocks, tubes, sheets or even films. However, it is not described how to integrate such a film into a semiochemical diffusion device.

There is therefore a need to develop a semiochemical diffusion device that is compact, refillable and allows semiochemicals to be diffused over periods ranging from 6 to 10 days.

### SUMMARY OF THE INVENTION

The object of the present invention is therefore a self-adhesive multilayer device successively comprising:
(1) a first adhesive layer;
(2) a support layer;
(3) a second adhesive layer;
(4) an active layer comprising a block copolymer and optionally a semiochemical substance, said block copolymer being an acrylic block copolymer comprising at least one alkyl polymethacrylate block and at least one alkyl polyacrylate block, a styrenic block copolymer comprising at least one polystyrene block and at least one optionally hydrogenated polydiene block, or a mixture thereof.

The device according to the present invention is a device for diffusing a semiochemical substance (e.g. C4 to C18 compounds with alcohols, ketones, aldehydes, esters, alkenes, alkynes, aromatics, etc.), positionable on numerous surfaces.

This is a multi-layer device comprising a thin polymeric film, obtained for example by extrusion, superimposed on a support structure itself composed of several layers to give the assembly the required mechanical strength, adhesive character and desired aesthetic appearance.

Thanks to the gradual release of a semiochemical substance, this device can be used to modify an animal's behavior and, in particular, to give pets such as dogs and cats a calming effect.

The active layer of this device is a thin layer (e.g. a few hundred micrometers) easily obtained by extrusion and easily impregnated with a semiochemical (e.g. by simply spraying the semiochemical substance, pure or mixed with other ingredients such as a solvent, onto the surface of this layer). Surprisingly, given its thinness, the active layer also enables this semiochemical substance to be released efficiently, in a controlled and balanced way, even when a mixture of active molecules is involved, for example as part of a pheromonal blend. This is because, despite the different volatilities of the molecules making up a pheromonal mixture, the active layer balances the diffusion speeds of these different molecules to obtain the desired pheromonal activity.

Once the active substance has been diffused, the device according to the invention, by the nature of its active layer, can be easily recharged by applying the semiochemical substance to its surface, for example by means of a spray. Recharging the active layer does not cause it to delaminate, despite swelling due to adsorption of the semiochemical substance. Thus, the active layer adheres well to the support layer via the second adhesive layer, even when loaded with semiochemicals.

The structure of the device according to the invention, in the form of a thin, self-adhesive, flexible and non-breaking film, also enables it to conform to any type of surface, whether flat or curved. Furthermore, its outward appearance is preserved over time (no whitening of the active layer, for example), allowing it to retain its aesthetic appeal.

Another object of the present invention is a kit comprising one or more self-adhesive multilayer devices according to the invention and a composition comprising a semiochemical substance.

A further object of the present invention is the use of a self-adhesive multilayer device according to the invention or of a kit according to the invention for the diffusion of a semiochemical substance, in particular for the absorption and diffusion of a semiochemical substance.

The present invention also relates to a method for diffusing a semiochemical substance comprising the following steps:
a) application of a self-adhesive multilayer device according to the invention to a substrate,
b) impregnation of the active layer of the self-adhesive multilayer device with a semiochemical by bringing the active layer into contact with the semiochemical,
c) diffusion of the semiochemical substance from the active layer of the self-adhesive multilayer device,
d) optionally, repetition of steps b) and c).

The present invention further relates to the use of a self-adhesive multilayer device according to the invention or a kit according to the invention for behavior modification in an animal.

### DETAILED DESCRIPTION OF THE INVENTION

### Self-Adhesive Multilayer Device

As previously indicated, the self-adhesive multilayer device according to the invention comprises at least 4 layers, namely (1) a first adhesive layer; (2) a support layer; (3) a second adhesive layer; and (4) an active layer.

The first adhesive layer is designed to be bonded to a surface, while the second adhesive layer serves to adhere the active layer to the support layer.

The adhesive layers can be made of any suitable adhesive material (in particular to enable the device to be bonded to any type of substrate), such materials being well known to a person skilled in the art. Thus, the adhesive layers will advantageously comprise, in particular be constituted by, an acrylic polymer.

The adhesive layers are typically 1 μm to 50 μm thick, particularly 2 μm to 20 μm, preferably 5 μm to 15 μm. Such thickness can be measured by optical microscopy.

The first adhesive layer can also be protected by a protective layer. This protective layer is removed prior to use, that is just before bonding the self-adhesive multilayer device to the chosen substrate.

The support layer is typically a layer of cellulose, that is paper, or a metal or plastic film.

It may also be printed on the side in contact with the second adhesive layer to form a decorative pattern. Printing can be carried out using an ink (e.g. screen-printing ink). Thus, the device according to the invention may include a non-uniformly distributed ink layer between the support layer and the second adhesive layer.

The support layer typically has a thickness of 1 μm to 200 μm, in particular 5 μm to 150 μm, preferably 10 μm to 100 μm, for example around 50 μm. Such thickness can be measured by optical microscopy.

The active layer is designed to be in contact with ambient air. It is made up of a film which, thanks to the microstructure of its material, is capable of absorbing and diffusing semiochemical substances. Diffusion takes place slowly according to a kinetic profile adapted to the application. Once the semiochemical substance has been diffused, the film can then be recharged with the semiochemical substance by bringing the film in contact with a composition containing the semiochemical substance.

This film is also flexible and deformable so that it can be positioned on non-planar surfaces and conform to the surface to which it is applied. Typically, the film material will have a tensile Young's modulus less than or equal to 1500 MPa (measured to ISO 527) and an elongation at break greater than or equal to 20% (measured to ISO 527).

Preferably, this film also has the property of being transparent, so that the support layer to which it is applied can be seen through. This makes it possible to see any decor printed on the support layer. Typically, the film material will have a haze less than or equal to 20% (measured according to ISO 13468) and a luminous transmittance (LT) greater than or equal to 80% (measured according to ISO 13468).

The active layer thus comprises a block copolymer and optionally a semiochemical substance, said block copolymer being an acrylic block copolymer comprising at least one alkyl polymethacrylate block and at least one alkyl polyacrylate block, a styrenic block copolymer comprising at least one polystyrene block and at least one optionally hydrogenated polydiene block, or a mixture thereof. Preferably, the block copolymer is an acrylic block copolymer.

In the context of the invention, “block copolymer” means a copolymer containing, in particular constituted by, a linear sequence of several different blocks, each block being constituted by a polymer chain, two adjacent blocks therefore being constituted by different polymer chains. A block copolymer constitutes a single macromolecule, so that each block is covalently linked to the next, either directly by a covalent bond, or via a constituent unit that is not an integral part of the blocks. The polymer chain constituting a block will advantageously result from the polymerization of one or more, in particular 1 or 2, monomer species, preferably one monomer species.

“Alkyl” means a linear or branched monovalent saturated hydrocarbon group. The alkyl group advantageously comprises 1 to 10 carbon atoms ((C₁-C₁₀)alkyl), in particular 1 to 8 carbon atoms ((C₁-C₈)alkyl), especially 1 to 6 carbon atoms ((C₁-C₆)alkyl), preferably 1 to 4 carbon atoms ((C₁-C₄)alkyl).

“Diene” means a linear or branched hydrocarbon group comprising two C═C double bonds, for example conjugated dienes (double bonds separated by a single bond), cumulated dienes (double bonds carried by the same carbon atom) or non-conjugated dienes (double bonds separated by two or more single bonds), preferably conjugated. The diene advantageously comprises 4 to 10 carbon atoms, in particular 4 to 8 carbon atoms, especially 4 to 6 carbon atoms, preferably 4 or 5 carbon atoms. Examples include butadiene and isoprene.

“Polydiene” means a polymer resulting from the polymerization of a diene.

The block copolymer is advantageously a bi-block copolymer or a tri-block copolymer, preferably a tri-block copolymer. When the block copolymer is a tri-block copolymer, it advantageously comprises at most 2 identical blocks, preferably 2 identical blocks, in particular 2 alkyl polymethacrylate or polystyrene blocks.

When the block copolymer is an acrylic block copolymer, the block copolymer comprises at least one alkyl polymethacrylate block and at least one alkyl polyacrylate block.

The alkyl polymethacrylate is preferably polymethyl methacrylate (PMMA) and/or the alkyl polyacrylate is preferably polybutyl acrylate (PBA) or a copolymer of butyl acrylate and 2-ethyl hexyl acrylate, preferably polybutyl acrylate (PBA).

The acrylic block copolymer is advantageously a bi-block copolymer or a tri-block copolymer, preferably a tri-block copolymer. When the acrylic block copolymer is a tri-block copolymer, it advantageously comprises at most 2 identical blocks, preferably 2 identical blocks, in particular 2 alkyl polymethacrylate blocks.

Advantageously, the acrylic block copolymer is a tri-block copolymer of the PMMA-PABu-PMMA type. This could be Nanostrength® M53 copolymer.

When the block copolymer is a styrenic block copolymer, the block copolymer comprises at least one polystyrene block and at least one polydiene block, optionally hydrogenated.

The optionally hydrogenated polydiene may be polybutadiene, polyisoprene, polyethylene-butylene (resulting from the hydrogenation of polybutadiene), or polyethylene-propylene (resulting from the hydrogenation of polyisoprene).

The styrenic block copolymer is advantageously a bi-block copolymer or a tri-block copolymer, preferably a tri-block copolymer. When the styrenic block copolymer is a tri-block copolymer, it advantageously comprises at most 2 identical blocks, preferably 2 identical blocks, in particular 2 alkyl polystyrene blocks. Advantageously, the styrenic block copolymer is a tri-block copolymer of the SBS (styrene-butadiene-styrene), SIS (styrene-isoprene-styrene), SEBS (styrene-(ethylene-butylene)-styrene) or SEPS (styrene-(ethylene-propylene)-styrene) type.

The active layer typically has a thickness of 5 μm to 500 μm, in particular 10 μm to 400 μm, especially 20 μm to 300 μm, for example 50 μm to 250 μm, preferably 100 μm to 250 μm, for example around 200 μm. Such thickness can be measured by optical microscopy.

This active layer can be prepared by extrusion and calendering. This produces a film of the required thickness.

The active layer may also comprise a semiochemical substance. If the active layer does not contain such a substance, it can be subsequently impregnated with such a semiochemical substance.

The active layer, particularly when impregnated with a semiochemical substance, can be protected by a protective layer, preferably waterproof, to be removed at the time of use, once the device has been bonded to the chosen substrate. This protective layer, preferably waterproof, may be made of any suitable material well known to a person skilled in the art. This could be an aluminized protective layer, for example.

When present, the semiochemical substance will advantageously represent from 1% to 80%, notably from 1% to 50%, in particular from 2% to 40%, more particularly from 5 to 30%, preferably from 5% to 20% by weight relative to the weight of the active layer.

The expression “semiochemical substance” qualifies a chemical substance emitted by a plant or an animal in the environment and that has a signal value between living beings. It may consist of a single molecule or a mixture of molecules.

Semiochemicals are classified into:
pheromones that enable communication between individuals of the same species, and
allomones, kairomones and synomones exchanged between animals or plants belonging to different species.

In the context of the present invention, the semiochemical substance will more particularly be an animal pheromone, in particular a mammalian pheromone.

Semiochemicals can be perceived by different organs. Thus, semiochemical substances may be perceived by smelling for volatile compounds, or by tasting for non-volatile compounds. The information carried by the semiochemical substances can enable the locating and recognition of a sexual partner, for example.

Semiochemical substances and more particularly pheromones are chemical compounds of which a large number of examples (8000) is given in the database accessible online, Pherobase (www.pherobase.com).

According to one embodiment of the invention, the semiochemical substance is a fatty-chain semiochemical substance, and is advantageously chosen from the group of pheromones, in particular animal pheromones. More specifically, it will be a volatile substance.

The expression “volatile” refers to the ease at which the semiochemical substance can go from the liquid state to the gaseous state, under ambient pressure and temperature conditions, that is, approximately 20° C. and atmospheric pressure (1013.25 hPa). A “volatile” liquid is one whose saturated vapor pressure at 20° C. is greater than 1 Pa, preferentially between 1 Pa and 3000 Pa, in particular between 1 Pa and 2500 Pa, more preferentially between 1 Pa and 1500 Pa, more preferentially between 1 Pa and 1000 Pa, in particular between 1 Pa and 700 Pa.

For the purposes of this invention, “fatty chain” means an aliphatic hydrocarbon chain, preferably linear or branched, saturated or unsaturated, comprising 5 to 24, in particular 5 to 18, preferably 6 to 16, carbon atoms.

The semiochemical substance according to the invention is advantageously selected from alkanols and alkenols with 5 to 18 carbon atoms, alkanals and alkenals with 5 to 18 carbon atoms, alkanones with 6 to 18 carbon atoms, alkyl or alkene acetates with 5 to 18 carbon atoms, 1,7-dioxaspirononane, 3- or 4-hydroxy-1,7-dioxaspiro-undecane, benzyl alcohol, Z-(9)-tricosene (muscalide), henicosane, diacetyl, alkanoic acids with 5 to 16 carbon atoms (e.g. caprylic acid, lauric acid), pinene, methylugenol, eugenol, 4-methoxy-cinnamaldehyde, estragol, indole, ethyldodecanoate, tert-butyl 4-chloro-2-ethylcyclohexane-carboxylate, tert-butyl 5-chloro-2-ethylcyclohexane-carboxylate, tert-butyl, mycrenone, cucurbitacin, trimedlide, (E,E)-8,10-dodecadien-1-ol (codlemone) and mixtures thereof.

Advantageously, the semiochemical substance may be chosen from among ferruginol, ferrugineone or a ferruginol-ferrugineone mixture.

Other examples of known fatty chain pheromones are Z-5-dodecenyl acetate, dodecenyl acetate, Z-7-dodecenyl acetate, E-7-dodecenyl acetate, Z-8-dodecenyl acetate, E-8-dodecenyl acetate, Z-9-dodecenyl acetate, E-9-dodecenyl acetate, E-10-dodecenyl acetate, 11-dodecenyl acetate, Z-9,11-dodecadienyl acetate, E-9,11-dodecadienyl acetate, Z-11-tridecenyl acetate, E-11-tridecenyl acetate, tetradecenyl acetate, E-7-tetradecenyl acetate, Z-8-tetradecenyl acetate, E-8-tetradacenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tri-decadienyl acetate, [beta]-ionone, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7,11-hexadecadienyl acetate, Z,Z-11,13-hexadecadienyl acetate, E,Z-11,13-hexadecadienyl acetate, Z, E-3,13-octadecadienyl acetate, E,Z-3,13-octadecadienyl acetate, E,E-3,13-octadecadienyl acetate, hexanol, heptanol, octanol, decanol, Z-6-nonenol, E-6-nonenol, 4-methyl-5-nonanol, 4-methyl-5-nonanone, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,10-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9,11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, e-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9,11-hexadecadienal, E,E-10,12-hexadecadienal, E,Z-10,12-hexadecadienal, Z,E-10,12-hexadecadienal, Z,Z-10,12-hexadecadienal, Z,Z-11,13-hexadecadienal, octadecanal, Z-11-octadecenal, E-13-octadecenal, Z-13-octadecenal, Z-5-decenyl-3-methyl butanoate, (+)-cis-7,8-epoxy-2-methyloctadecane (disparlure), 3-methyl-2-cyclohexen-1-ol (seudenol), 6-methyl-5-hepten-2-ol (sulcatol), 2-methyl-6-methylene-7-octen-4-ol (ipsenol), 2-methyl-6-methylene-2,7-octadien-4-ol (ipsdienol), cis-2-isopropenyl-1-methylcyclobutane-ethanol (grandiure I), Z-3,3-dimethyl-1-cyclohexane-ethanol (grandiure II), Z-3,3-dimethyl-1-cyclohexane-acetaldehyde (grandiure III), E-3,3-dimethyl-1-cyclohexane acetaldehyde (grandiure IV), cis-4,6,6-trimethylbicyclo[3,1,1]hept-3-en-2-ol (cis-2-verbenol), 2-methyl-3-buten-2-ol, 4-methyl-3-heptanol, 2-methyl-3-buten-2-ol, 4-methyl-3-heptanol, 2,6,6-trimethylbicyclo[3,1,1]hepten-2-ene ([alpha]-pinene), 4,11,11-trimethyl-8-methylene-bicyclo[7,2,0]undecane ([alpha]-caryophyllene), Z-9-tricosene (muscalide), [alpha]-multistriatine, 2-(2-endo,4-endo)-5-ethyl-2,4-dimethyl-6,8-dioxabicyclo[3,2,1]octane, 3,3,7-trimethyl-2,9-dioxatricyclo[3,3,1,0]nonane (lineatine), 2-ethyl-1,6-dioxaspiro[4,4]nonane (chalcogran), 1,5-dimethyl-6,8-dioxabicyclo[3,2,1]octane (frontaline), endo-7-ethyl-5-methyl-6,8-dioxabicyclo[3,2,1]octane (endo-brevicomine), exo-7-ethyl-5-methyl-6,8-dioxabicyclo[3,2,1]octane (exo-brevicomine), (Z)-5-(1-decenyl)dihydro-2-(3H)-furanone, 3,7,11-trimethyl-2,6,10-dodecatrien-1-ol (farnesol), 3,7,11-trimethyl-1,6,10-dodecatrien-3-ol (nerolidol), 3-methyl,6-(1-methylethenyl)-9-decen-1-ol acetate, (Z)-3-methyl-6-(1-methylethenyl)-3,9-decadien-1-ol acetate, (E)-3,9-methyl-6-(1-methyl-ethenyl)-5,8-decadien-1-ol acetate, 3-methylene-7-methyl-octen-1-ol propionate, (Z)-3,7-dimethyl-2,7-octadien-1-ol propionate, or (Z)-3,9-dimethyl-6-(1-methyl-ethenyl)-3,9-decadien-1-ol. The semiochemical substance can be any of these fatty-chain pheromones or a mixture thereof.

The semiochemical substance according to the invention may also be chosen from fatty acid esters, and more particularly methyl or ethyl fatty acid esters, the fatty acid advantageously having from 5 to 18 carbon atoms and in particular from 8 to 18 carbon atoms. It could be methyl laurate.

In one embodiment, the semiochemical substance is selected from the group of pheromones, in particular animal pheromones, especially mammalian pheromones.

The mammals according to the invention are preferentially selected from dogs, cats, horses, cattle and pigs.

The animal pheromone, in particular from mammals, can thus be selected from pheromones of dogs, cats, horses, cattle and pigs.

Preferentially, the animal pheromone is an appeasing pheromone.

In a preferential way, the mammalian pheromones are appeasing pheromones such as apaisine, which is secreted by females during lactation or facial pheromones in cats.

Among animal pheromones, social regulation pheromones such as urine markers or feline interdigital pheromones to mark their territory can also be distinguished. The pheromones according to the invention are natural or synthetic pheromones.

In a particular embodiment of the invention, the semiochemical substance may be protected against the action of light and/or oxygen, in particular through the use of antioxidants and/or UV stabilizers. Thus the active layer may contain at least one additive selected from antioxidants, UV stabilizers and mixtures thereof.

The antioxidants may be chosen from the group consisting of vitamin E, butylated hydroxyanisole (BHA), butylated hydroxytoluene (BHT) and mixtures thereof. These antioxidants protect the semiochemical from degradation by oxygen and can be added in quantities ranging from 0.1% to 3%, particularly between 0.5% and 2% by weight based on the weight of the active layer.

The UV stabilizers may be selected from the group consisting of beta-carotene, p-aminobenzoic acid, hindered amines and hindered alkoxyamines and mixtures thereof. The hindered amines can be 4-tetramethylpiperidine derivatives, known as HALS (hindered amine light stabilizers) and described in Schaller, C., Rogez, D. & Braig, A. “Hindered amine light stabilizers in pigmented coatings.” J Coat Technol Res 6, 81-88 (2009). The hindered alkoxyamines can be Solvay's TEMPO, for example. These UV stabilizers protect the semiochemical from degradation by light and can be added in quantities ranging from 0.1% to 3%, particularly between 0.5% and 2% by weight based on the weight of the active layer.

The self-adhesive multilayer device according to the invention can be of any size and shape, depending on the intended application.

### Kit

The kit according to the invention comprises one or more self-adhesive multilayer devices according to the invention and a composition, preferably liquid, comprising a semiochemical substance.

According to one embodiment, the self-adhesive multilayer devices according to the invention do not comprise any semiochemical substance.

The active layer of these devices will advantageously be impregnated with a semiochemical substance using the composition included in the kit. This impregnation can be carried out, for example, by spraying, brushing or rolling, or by soaking, preferably by spraying, preferably once the device has been bonded to the chosen substrate.

The composition, preferably liquid, advantageously comprises, in particular consists of, a semiochemical substance, optionally solubilized in a solvent. The solvent may in particular be an ether such as di(propylene glycol) methyl ether, an alcohol such as isopropanol, and so on. Preferably, the composition contains no solvent.

The composition may also comprise one or more antioxidant agents and one or more anti-UV agents as defined above to protect the semiochemical substance against the action of UV and/or oxygen.

Additives such as stabilizers, preservatives or rheology agents may also be present in the composition.

Preferably, the composition is contained in a sprayable container. It can also be contained in a container fitted with a drip system or a brush.

### Diffusion Method

The self-adhesive multilayer device according to the invention and the kit according to the invention are useful for diffusing a semiochemical substance, in particular according to a method comprising:
a) application of a self-adhesive multilayer device according to the invention to a substrate,
b) impregnation of the active layer of the self-adhesive multilayer device with a semiochemical by bringing the active layer into contact with the semiochemical,
c) diffusion of the semiochemical substance from the active layer of the self-adhesive multilayer device,
d) optionally, repetition of steps b) and c).

Step a) can be performed before or after step b).

### Step a):

The self-adhesive multilayer device according to the invention can be applied to any type of substrate, whether flat or curved, since its flexible structure enables the device to conform to the shape of the substrate, whatever the material of the substrate.

Thus, the substrate can be made of a material selected from the group consisting of glass, textile, paper, cardboard, plastic, brick, concrete, wood, leather, plant fibers, metal, ceramics, and a combination thereof.

A substrate may comprise or consist of a continuous surface that is more or less extended and more or less flat, such as an opaque or transparent barrier, for example a wall, floor or glazed area such as a window, or an item of furniture, such as a closet, or a plastic crate.

A substrate can also comprise an item, that is a discrete or individualized object. This item can take the form of a post, stake, fence, palisade, staple, hook, cardboard plate, glass plate, plastic plate, metal plate, rag, tarpaulin, bag, transport crate, T-shirt, and so on.

### Step b):

The active layer can be impregnated by simply contacting the active layer with a composition, preferably liquid, comprising or consisting of the semiochemical substance, such as the composition in the kit according to the present invention.

Thus, the composition, preferably liquid, will advantageously comprise, in particular consist of, a semiochemical substance, optionally solubilized in a solvent. Additives such as stabilizers, preservatives or rheology agents may also be present in the composition. The solvent may in particular be an ether such as di(propylene glycol) methyl ether, an alcohol such as isopropanol, and so on. Preferably, the composition contains no solvent.

Such contact can be achieved, for example, by spraying the composition onto the active layer, brushing or rolling the active layer with the composition, or soaking the active layer in the composition.

In view of the price of semiochemicals, an application that limits losses will be favored, such as a spray application.

### Step c):

Once the active layer has been impregnated with the semiochemical substance, the semiochemical substance can gradually diffuse through the active layer and modify the behavior of an animal in its immediate environment.

This diffusion will advantageously be spread out over a period of 6 to 10 days.

### Step d):

An advantage of the device according to the invention is its ability to be recharged with semichemical substance, enabling steps b) and c) to be repeated one or more times.

Thus, once the initial quantity of semiochemical substance present in the active layer has been diffused, the active layer of the device according to the invention can be reimpregnated with semiochemical substance under the conditions of step b).

### Use

The present invention further relates to the use of a self-adhesive multilayer device according to the invention or a kit according to the invention for behavior modification in an animal.

Pheromones can be used to influence the behavior of animals such as pets, horses and pigs, which are subject to stressful situations (noise, transport, separation, etc.) linked to their environment. The pheromone(s) will be chosen according to the animal (e.g. dog, cat, etc.) for which you wish to modify the behavior in the situation encountered. The pheromone, for example, can be chosen to soothe the animal during transport. The animal crate is often a stressful situation, as the animal loses its bearings and is confronted with new stimuli, both olfactory and visual.

Preferably, the pheromone is an animal pheromone, in particular a mammalian pheromone.

The mammals according to the invention are preferentially selected from dogs, cats, horses, cattle and pigs.

The animal pheromone, in particular from mammals, can thus be selected from pheromones of dogs, cats, horses, cattle and pigs.

Preferentially, the animal pheromone is an appeasing pheromone.

In a preferential way, the mammalian pheromones are appeasing pheromones such as apaisine, which is secreted by females during lactation or facial pheromones in cats.

Among animal pheromones, social regulation pheromones such as urine markers or feline interdigital pheromones to mark their territory can also be distinguished.

The present invention is illustrated by the following non-limiting examples.

### EXAMPLES

### Example 1: Absorption Properties Depending on the Type of Impregnation Material Used

The materials tested are injected in the form of 5A tensile test specimens (ISO 3167). The specimens are weighed and then brought into contact with methyl laurate by soaking in a methyl laurate bath at a temperature of 20° C. The specimens are recovered after one hour, drained and quickly surface-washed with ethanol, then air-dried and weighed. The difference in weight observed in relation to the initial mass of the specimen represents the quantity impregnated. The specimens are then diffused in a ventilated oven at 30° C. for several days. The results are presented in Table 1 below.

TABLE 1

| Specimen material | | | M53* | PRnew* | VMS* | PU |
|---|---|---|---|---|---|---|
| Impregnated quantity (mg) | | | 2295 | 1180 | 61 | 14 |
| over 1 h | | | | | | |
| Percentage of impregnation | | | 70% | 40% | 2% | 0.5% |
| Quantity (mg) | 4 | days | 812 | 964 | 57 | 8 |
| diffused under | | | (35%) | (82%) | (93%) | (57%) |
| study at 30° C. | 6 | days | 1282 | 1074 | 59 | 12 |
| | | | (56%) | (91%) | (96%) | (85%) |
| | 10 | days | 1698 | 1176 | 60 | 13 |
| | | | (73%) | (99%) | (98%) | (92%) |
| | 12 | days | 1864 | 1180 | 61 | 14 |
| | | | (81%) | (100%) | (100%) | (100%) |

*M53 = Nanostrength ® M53; PRNEW = Pebax ® Rnew; PMV = Pebax ® MV (polyether block amide); PU = polyurethane

The results show that a variation in the microstructure or nature of the monomers can drastically change the absorption and scattering properties. Nanostrength® M53 (acrylic block copolymer according to the invention) thus has a high adsorption capacity (impregnation) combined with a sufficiently long and controlled diffusion of methyl laurate (semiochemical substance) over time (retention capacity).

### Example 2: Physical Measurements on 5ª Specimens Made of Raw Material and Material Impregnated with Methyl Laurate

5A tensile test specimens are tested on tensile test stands or on a durometer. They may or may not have been previously impregnated with methyl laurate (ML) using the method described in Example 1. The rate of impregnation is modulated by leaving the specimens in the methyl laurate solution for longer or shorter periods.

Young's modulus, elongation at break and Shore hardness are then measured in accordance with ISO 527 for Young's modulus and elongation at break, and ISO 868 for Shore hardness. The results obtained are presented in Table 2 below.

TABLE 2

| | Young's | Elongation at | Shore hardness (deg. |
|---|---|---|---|
| Test specimen | modulus (MPa) | break (%) | Shore from 0 to 100) |
| M53 | 157 | 30 | 37 |
| M53 impregnated | 143 | 43 | 32 |
| with 5% ML | | | |
| M53 impregnated | 48 | 48 | 22 |
| with 12% ML | | | |

The results show that Nanostrength® M53 meets the flexibility criteria required by the application, whatever the rate of impregnation.

### Example 3: Impact of Material Thickness

The aim of this test is to demonstrate the importance of choosing the right active layer thickness. For this purpose, two Nanostrength® M53 objects of different thicknesses were impregnated with a defined amount of methyl laurate (ML) at room temperature by depositing the methyl laurate on the surface to be impregnated.

The first object is a self-adhesive multilayer device according to the invention of 5×5 cm² comprising:
a first acrylic polymer adhesive layer of about 10 μm;
a layer of paper (cellulose) about 50 μm thick, screen-printed with an ink;
a second acrylic polymer adhesive layer of about 10 μm;
a 200 μm film of Nanostrength® M53 polymer.

The second is a 5×5 cm² Nanostrength® M53 plate with a thickness of 5 mm. In both cases, impregnation yields exceeded 99%.

Both objects were diffused at room temperature. The results obtained are presented in Table 3 below.

TABLE 3

| | Device according to the | | | | | |
|---|---|---|---|---|---|---|
| | invention (5 × 5 cm²) | | | Plate (5 × 5 cm²) | | |
| Thickness* | 0.2 mm | | | 5 mm | | |
| Quantity ML | 126 mg | | | 130 mg | | |
| impregnated | | | | | | |
| | | | Average | | | Average |
| | | Dif- | instan- | | Dif- | instan- |
| | Residual | fused | taneous | Residual | fused | taneous |
| | ML | ML | diffusion | ML | ML | diffusion |
| | mass | mass | rate | mass | mass | rate |
| Time | (mg) | (%) | (mg/h) | (mg) | (%) | (mg/h) |
| 1.5 h | 121 | 5 | 3.7 | 114 | 12 | 10.6 |
| 18 h | 90 | 29 | 1.9 | 85 | 35 | 1.7 |
| 96 h | 25 | 80 | 0.8 | 45 | 65 | 0.5 |
| 120 h | 18 | 86 | 0.3 | 40 | 69 | 0.2 |
| 144 h | 15 | 88 | 0.1 | 35 | 73 | 0.2 |

*Nanostrength ® M53 material to be impregnated with methyl laurate

The results show that the device according to the invention diffuses more with a residual amount of methyl laurate of 11% after 144 h, while the thicker material shows more than 25% residual methyl laurate. In addition, the device according to the invention shows a better control of diffusion in the first 15 hours of diffusion.

Finally, the diffusion efficiency over a given period, 6 days in the example, is better for the device according to the invention, with 88.2% of methyl laurate diffused, compared with only 73.2% for the thicker material.

Thus, more constant diffusion over time is achieved when the material is in the form of a thin film, compared with a thick plate. The diffusion rate is lower at shorter times and higher at longer times, which ensures that the instantaneous dose emitted by a thin diffusion system is more even over time than that emitted by a thick diffusion system.

### Example 4: Semiochemical Liquid Composition

Several types of formulation can be envisaged to recharge the self-adhesive multilayer device according to the invention:
Formulation A: semiochemical substance solubilized in a penetrating organic solvent;
Formulation B: semiochemical substance solubilized in a non-penetrating organic solvent;
Formulation C: pure semiochemical substance.

Formulation A facilitates penetration of the semiochemical into the active layer material. Like formulation C, formulation B does away with the need for solvents, since only the semiochemical substance penetrates the active layer material.

### Example of Formulation A:

Into a 50 mL bottle fitted with a spray head, the following are mixed (in % w/w): lauric acid (2%), oleic acid (2%) and di(propylene glycol) methyl ether (96%).

The mixture is homogenized. The mixture is then sprayed onto a device according to the invention at a distance of 5 cm. The impregnation rate observed after 30 min is 99% of the mixture.

### Example of Formulation B:

In a 50 ml bottle fitted with a spray head are mixed (in % w/w): methyl laurate (2%), methyl oleate (2%) and isopropanol (96%).

The mixture is homogenized. The mixture is then sprayed onto a device according to the invention at a distance of 5 cm. The impregnation rate observed was 3.7% of the mixture, with a 92% impregnation efficiency of the 2 active ingredients.

### Example of Formulation C:

A 20/80 (w/w) mixture of methyl laurate and methyl oleate is introduced into a dropper bottle.

5 drops of the mixture are deposited on the device according to the invention. The impregnation rate measured after 30 min is 97%.

1. A self-adhesive multilayer device comprising successively:
(1) a first adhesive layer;
(2) a support layer;
(3) a second adhesive layer;
(4) an active layer having a thickness of 5 μm to 500 μm and comprising a block copolymer and optionally a semiochemical substance, said block copolymer being an acrylic block copolymer comprising at least one alkyl polymethacrylate block and at least one alkyl polyacrylate block.

2. The self-adhesive multilayer device according to claim 1, wherein the block copolymer is a bi-block copolymer or a tri-block copolymer.

3. The self-adhesive multilayer device according to claim 2, wherein the tri-block copolymer comprises at most 2 identical blocks.

4. The self-adhesive multilayer device according to claim 1, wherein the alkyl polyacrylate is polymethyl methacrylate (PMMA) and/or the alkyl polyacrylate is selected from the group consisting of polybutyl acrylate (PBA) and a copolymer of butyl acrylate and 2-ethylhexyl acrylate.

5. The self-adhesive multilayer device according to claim 1, wherein the acrylic block copolymer is a tri-block copolymer of the PMMA-PABu-PMMA type.

6. The self-adhesive multilayer device according to claim 1, wherein the active layer comprises the semiochemical substance and the semiochemical substance is an animal pheromone.

7. The self-adhesive multilayer device according to claim 1, wherein the active layer has a thickness of 10 μm to 400 μm.

8. The self-adhesive multilayer device according to claim 1, wherein the first adhesive layer and the second adhesive layer each comprise an acrylic polymer, and advantageously have a thickness of from 1 μm to 50 μm.

9. The self-adhesive multilayer device according to claim 1, wherein the first adhesive layer and/or the active layer is protected by a protective layer intended to be removed before use.

10. The self-adhesive multilayer device according to claim 1, wherein the support layer is made of cellulose, and advantageously has a thickness of 1 μm to 200 μm.

11. The self-adhesive multilayer device according to claim 1, wherein the support layer is printed on its side in contact with the second adhesive layer.

12. A kit comprising one or more self-adhesive multilayer devices according to claim 1 and a composition comprising a semiochemical substance.

13. A method for diffusing a semiochemical substance comprising the following steps:
a) application of a self-adhesive multilayer device according to claim 1,
b) impregnation of the active layer of the self-adhesive multilayer device with a semiochemical by bringing the active layer into contact with the semiochemical,
c) diffusion of the semiochemical substance from the active layer of the self-adhesive multilayer device,
d) optionally, repetition of steps b) and c).

14. The method according to claim 13, wherein the substrate is made of a material selected from the group consisting of glass, textile, paper, cardboard, plastic, brick, concrete, wood, leather, plant fibers, metal, ceramics, and a combination thereof.

15. The method according to claim 13, wherein the substrate is a wall, a floor, a window, a piece of furniture, a plastic crate, a stake, a fence, a palisade, a staple, a hook, a cardboard plate, a glass plate, a plastic plate, a metal plate, a cloth, a tarpaulin, a bag, a transport crate or a T-shirt.

16. A use of a self-adhesive multilayer device according to claim 1 for behavior modification in an animal.

17. A use of a kit according to claim 12 for behavior modification in an animal.
